(19) United States
(12) Patent Application Publication
(10) Pub. No.: US 2020/0099051 A1
(43) Pub. Date: Mar. 26, 2020

(54) NEGATIVE ELECTRODE FOR LITHIUM ION BATTERY AND LITHIUM ION BATTERY

(71) Applicant: Envision AESC Energy Devices Ltd., Sagamihara-shi, Kanagawa (JP)

(72) Inventor: Kouzou TAKEDA, Sagamihara-shi (JP)

(73) Assignee: Envision AESC Energy Devices Ltd., Sagamihara-shi, Kanagawa (JP)

(21) Appl. No.: 16/497,911

(22) PCT Filed: Jan. 31, 2018
(86) PCT No.: PCT/JP2018/003128

§ 371 Date: Sep. 26, 2019

(30) Foreign Application Priority Data
Mar. 31, 2017 (JP) 2017-069661

(51) Int. Cl. H01M 4/587; H01M 4/36; H01M 4/62; H01M 4/133; H01M 10/0525

(52) U.S. Cl. CPC H01M 4/587; H01M 4/366; H01M 2004/027; H01M 4/133; H01M 10/0525; H01M 4/622

(57) ABSTRACT

A negative electrode (100) for a lithium ion battery of the present invention includes a collector layer (101); and a negative electrode active material layer (103) which is provided on at least one surface of the collector layer (101) and contains, as a negative electrode active material, a surface-coated graphite material formed by coating at least apart of a surface with amorphous carbon. Further, a water vapor saturation adsorption amount of the negative electrode active material layer (103) measured using the following method is greater than or equal to 0.03 cm³ (STP)/g and less than or equal to 0.25 cm³ (STP)/g.

(Method)

The negative electrode active material layer (103) (3.0 g) is dried at 220° C. for 2 hours in a nitrogen atmosphere. Next, the dried negative electrode active material layer (103) is allowed to adsorb water vapor at 25° C. using a constant capacity method, and the water vapor saturation adsorption amount of the negative electrode active material layer (103) is calculated.

### TECHNICAL FIELD

The present invention relates to a negative electrode for a lithium ion battery and a lithium ion battery.

### BACKGROUND ART

Lamination type lithium ion batteries have been used as, for example, power sources for electronic equipment such as notebook computers or mobile phones, and power sources for automobiles such as hybrid vehicles or electric vehicles.

A lamination type lithium ion battery has a structure in which a power generation element formed of a positive electrode, an electrolyte, and a negative electrode are sealed by a laminate film.

A negative electrode used for a lamination type lithium ion battery is typically and mainly formed of a negative electrode active material layer and a collector layer. The negative electrode active material layer is obtained by, for example, coating a surface of the collector layer which is metal foil or the like with a negative electrode slurry containing a negative electrode active material, an aqueous binder resin, a thickener, a conductive assistant, and the like and drying the slurry.

As the techniques related to such a negative electrode for a lithium ion battery, for example, those described in Patent Documents 1 to 3 are exemplified.

Patent Document 1 (Japanese Unexamined Patent Publication No. H10-012241) discloses a negative electrode material for a lithium ion secondary battery which is a graphite-carbon composite material including cores of graphite particles having an average particle diameter of less than or equal to 50 μm, and a carbon layer applied to a surface of each graphite particle according to a chemical vapor deposition treatment method, in which the specific surface area of the graphite-carbon composite material is less than or equal to 1 m²/g, and the equilibrium adsorbed moisture content is less than or equal to 0.3 wt %.

Patent Document 1 describes that since the graphite-carbon composite material obtained by using a graphite particle having a large charge capacity as a core and applying a chemical vapor deposition treatment to the surface of the graphite particle so that the surface of the graphite particle is coated with pyrolytic carbon having a small specific surface area has a large charge amount and a high initial discharge efficiency, the graphite-carbon composite material may have a large reversible discharge capacity.

Patent Document 2 (Japanese Unexamined Patent Publication No. H11-204109) discloses a method of producing a negative electrode material for a lithium ion secondary battery which uses a nonaqueous electrolytic solution and uses a carbon material as a negative electrode material, including: forming a graphite-carbon composite material by using graphite particles having an average particle diameter of 1 to 50 μm as cores and coating each surface of the graphite particle with a carbon layer according to a chemical vapor deposition treatment method.

Patent Document 2 describes that decomposition of the solvent of the electrolytic solution can be suppressed and a lithium ion secondary battery with a high capacity can be realized by employing the negative electrode material obtained using the above-described production method.

Patent Document 3 (PCT International Publication No. WO2015/037367A) describes a nonaqueous electrolytic solution secondary battery including an electrode element in which a positive electrode and a negative electrode are disposed to face each other, a nonaqueous electrolytic solution, and an exterior body including the electrode element and the nonaqueous electrolytic solution, in which the moisture content in the negative electrode is in a range of 50 ppm to 1000 ppm, and the nonaqueous electrolytic solution contains a cyclic sulfonic acid ester derivative having a specific structure as an additive.

Patent Document 3 describes that the nonaqueous electrolytic solution secondary battery having the above-described configuration has excellent coulomb efficiency.

### RELATED DOCUMENT

### Patent Document

[Patent Document 1] Japanese Unexamined Patent Publication No. H10-012241

[Patent Document 2] Japanese Unexamined Patent Publication No. H11-204109

[Patent Document 3] PCT International Publication No. WO2015/037367A

### SUMMARY OF THE INVENTION

### Technical Problem

According to the examination conducted by the present inventors, it became evident that the amount of gas to be generated at the time of initial charge is large in a case where a lamination type lithium ion battery of the related art is used and the battery is swollen after the initial charge in some cases. In a case where the battery is swollen, there is a concern that the battery is blown out or stress is applied to a welding portion of the exterior body.

Here, in a case of the lamination type lithium ion battery, a step of determining the quality of the battery is usually performed by carrying out an aging treatment of allowing the battery to stand at a certain temperature after the initial charge.

According to the examination conducted by the present inventors, it became evident that swelling of a battery is suppressed in a case where a lithium ion battery in which the amount of gas to be generated at the time of initial charge is small is used, but degradation of the discharge capacity after the aging treatment becomes significant, in other words, the aging efficiency is degraded in some cases.

In other words, the present inventors found that there is a trade-off relationship between suppression of the swelling of a battery and improvement of the aging efficiency in a lamination type lithium ion battery of the related art.

The present invention has been made in consideration of the above-described circumstances, and an object thereof is to provide a negative electrode for a lithium ion battery which is capable of realizing a lamination type lithium ion battery which has excellent aging efficiency and is unlikely to be swollen.

### Solution to Problem

The present inventors repeatedly conducted intensive examination in order to solve the above-described problems. As the result, it was found that swelling of the battery at the time of initial charge can be suppressed while maintaining excellent aging efficiency by setting the water vapor adsorption amount of the negative electrode active material to be in a specific range, thereby completing the present invention.

According to the present invention, there is provided a negative electrode for a lithium ion battery including: a collector layer; and a negative electrode active material layer which is provided on at least one surface of the collector layer and contains, as a negative electrode active material, a surface-coated graphite material formed by coating at least a part of a surface with amorphous carbon, in which a water vapor saturation adsorption amount of the negative electrode active material layer measured using the following method is greater than or equal to 0.03 cm³ (STP)/g and less than or equal to 0.25 cm³ (STP)/g.

(Method)

3.0 g of the negative electrode active material layer is dried at 220° C. for 2 hours in a nitrogen atmosphere. Next, the dried negative electrode active material layer is allowed to adsorb water vapor at 25° C. using a constant capacity method, and the water vapor saturation adsorption amount of the negative electrode active material layer is calculated.

Further, according to the present invention, there is provided a lithium ion battery including the negative electrode for a lithium ion battery.

### Advantageous Effects of Invention

According to the present invention, it is possible to provide a negative electrode for a lithium ion battery which is capable of realizing a lamination type lithium ion battery which has excellent aging efficiency and is unlikely to be swollen.

### BRIEF DESCRIPTION OF THE DRAWINGS

The above-described purpose and other purposes, features, and advantages will become more apparent based on the preferred embodiments described below and the accompanying drawings.

FIG. 1 is a cross-sectional view illustrating an example of a structure of a negative electrode for a lithium ion battery according to an embodiment of the present invention.

FIG. 2 is a cross-sectional view illustrating an example of a structure of a lithium ion battery according to the embodiment of the present invention.

### DESCRIPTION OF EMBODIMENTS

Hereinafter, embodiments of the present invention will be described with reference to the accompanying drawings. In all drawings, the same constituent elements are denoted by the same reference numerals, and the description thereof will not be repeated. Further, the shape, the size, and the positional relationship of each constituent element in the drawings are schematically shown in order to facilitate the understanding of the present invention, and the size thereof is different from the actual size. Further, the numerical ranges “A to B” in the present embodiment indicate greater than or equal to A and less than or equal to B unless otherwise specified.

<Negative Electrode for Lithium Ion Battery>

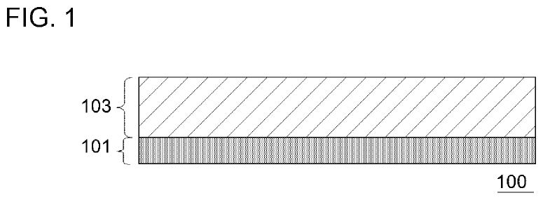

First, a negative electrode 100 for a lithium ion battery according to the present embodiment will be described. FIG. 1 is a cross-sectional view illustrating an example of the structure of the negative electrode 100 for a lithium ion battery according to the embodiment of the present invention.

The negative electrode 100 for a lithium ion battery according to the present embodiment includes a collector layer 101; and a negative electrode active material layer 103 which is provided on at least one surface of the collector layer 101 and contains, as a negative electrode active material, a surface-coated graphite material formed by coating at least a part of a surface thereof with amorphous carbon.

Further, the water vapor saturation adsorption amount of the negative electrode active material layer 103 measured using the following method is greater than or equal to 0.03 cm³ (STP)/g and less than or equal to 0.25 cm³ (STP)/g.

(Method)

The negative electrode active material layer 103 (3.0 g) is dried at 220° C. for 2 hours in a nitrogen atmosphere. Next, the dried negative electrode active material layer 103 is allowed to adsorb water vapor at 25° C. using a constant capacity method, and the water vapor saturation adsorption amount of the negative electrode active material layer 103 is calculated.

Here, more specifically, the water vapor saturation adsorption amount of the negative electrode active material layer 103 can be measured using a commercially available water vapor adsorption amount measuring device (for example, trade name: BELSORP, manufactured by Bel Japan Inc.) using a constant capacity method.

Further, cm³ (STP)/g indicates the volume of water vapor saturated and adsorbed per 1 g of the negative electrode active material layer 103 and also indicates the volume of water vapor in a standard state (0° C., 1 atm).

According to the examination conducted by the present inventors, it became evident that the amount of gas to be generated at the time of initial charge is large in a case where a lamination type lithium ion battery of the related art is used and the battery is swollen after the initial charge in some cases. In a case where the battery is swollen, there is a concern that the battery is blown out or stress is applied to a welding portion of the exterior body.

Here, in a case of the lamination type lithium ion battery, a step of determining the quality of the battery is usually performed by carrying out an aging treatment of allowing the battery to stand at a certain temperature after the initial charge.

According to the examination conducted by the present inventors, it became evident that swelling of a battery is suppressed in a case where a lithium ion battery in which the amount of gas to be generated at the time of initial charge is small is used, but degradation of the discharge capacity after the aging treatment becomes significant, in other words, the aging efficiency is degraded in some cases.

In other words, the present inventors found that there is a trade-off relationship between suppression of the swelling of a battery and improvement of the aging efficiency in a lamination type lithium ion battery of the related art.

As the result of intensive examination conducted by the present inventors, it was found that swelling of the battery at the time of initial charge can be suppressed while maintaining excellent aging efficiency by setting the water vapor adsorption amount of the negative electrode active material layer 103 to be measured according to the above-described method to be greater than or equal to 0.03 cm³ (STP)/g and less than or equal to 0.25 cm³ (STP)/g.

The upper limit of the water vapor saturation adsorption amount of the negative electrode active material layer 103 is less than or equal to 0.25 cm³ (STP)/g, but is preferably less than or equal to 0.20 cm³ (STP)/g, more preferably less than or equal to 0.16 cm³ (STP)/g, and particularly preferably less than or equal to 0.13 cm³ (STP)/g. In the negative electrode 100 for a lithium ion battery according to the present embodiment, the aging efficiency can be improved while suppressing the swelling of the lithium ion battery to be obtained by setting the water vapor adsorption amount of the negative electrode active material layer 103 to be less than or equal to the above-described upper limit.

The lower limit of the water vapor saturation adsorption amount of the negative electrode active material layer 103 is greater than or equal to 0.03 cm³ (STP)/g, but is preferably greater than or equal to 0.04 cm³ (STP)/g and particularly preferably greater than or equal to 0.05 cm³ (STP)/g. In the negative electrode 100 for a lithium ion battery according to the present embodiment, swelling of the battery can be effectively suppressed while suppressing degradation of the aging efficiency of the lithium ion battery to be obtained by setting the water vapor saturation adsorption amount of the negative electrode active material layer 103 to be greater than or equal to the above-described lower limit.

In the present embodiment, the negative electrode active material layer 103 whose water vapor saturation adsorption amount is in the above-described range can be realized by highly controlling the production conditions such as (A) the compounding ratio of the negative electrode active material layer 103, (B) the types of the surface-coated graphite material, the binder resin, the thickener, and the conductive assistant constituting the negative electrode active material layer 103, (C) a method of preparing a negative electrode slurry used for forming the negative electrode active material layer 103, (D) a method of drying the negative electrode slurry, (E) a method of pressing the negative electrode, and the like.

More specifically, the coating amount of amorphous carbon in the surface-coated graphite material, the baking temperature at the time of coating the graphite material with amorphous carbon, the mixing procedures of respective components at the time of preparing the negative electrode slurry, the method of drying the negative electrode slurry, and the uniform pressure to be applied to the negative electrode active material layer 103 in the film thickness direction are exemplified as factors for controlling the water vapor saturation adsorption amount of the negative electrode active material layer 103.

Next, each component constituting the negative electrode active material layer 103 according to the present embodiment will be described.

The negative electrode active material layer 103 contains a negative electrode material as an indispensable component and further contains a binder resin, a thickener, and a conductive assistant as necessary.

(Negative Electrode Active Material)

The negative electrode active material contained in the negative electrode active material layer 103 according to the present embodiment contains a surface-coated graphite material in which at least a part of the surface is coated with amorphous carbon.

In other words, in the surface-coated graphite material according to the present embodiment, a graphite material is as a core material and at least a part of the surface of the graphite material is coated with amorphous carbon. It is preferable that particularly an edge portion of the graphite material is coated with the amorphous carbon. By the edge portion of the graphite material being coated with the amorphous carbon, irreversible reactions between the edge portion and the electrolytic solution can be suppressed, and thus degradation of initial charge and discharge efficiency due to an increase in irreversible capacity can be further suppressed.

Here, examples of the amorphous carbon include soft carbon and hard carbon.

The graphite material used as a core material is not particularly limited as long as the graphite material is a typical graphite material which can be used for a negative electrode of a lithium ion battery. Examples thereof include natural graphite and artificial graphite produced by performing a heat treatment on petroleum-based and coal-based cokes. In the present embodiment, these graphite materials may be used alone or in combination of two or more kinds thereof. Among these, from the viewpoint of the cost, natural graphite is preferable.

Here, the natural graphite indicates graphite naturally produced as an ore. In the natural graphite used as the core material of the present embodiment, the production area, the property, and the type thereof are not particularly limited.

Further, the artificial graphite indicates graphite created by an artificial technique or graphite close to a perfect crystal of graphite. Such artificial graphite is obtained by performing a baking step and a graphitization step using tar or coke obtained from residues and the like generated due to dry distillation of coal and distillation of crude oil as a raw material.

The surface-coated graphite material according to the present embodiment can be prepared by mixing the graphite material with an organic compound which is carbonized by the baking step to become amorphous carbon having a crystallinity lower than that of the graphite material and forming the organic compound into baked carbon.

The organic compound to be mixed with the graphite material is not particularly limited as long as the organic compound is carbonized by being baked and amorphous carbon having a crystallinity lower than that of the graphite material is obtained, and examples thereof include tar such as petroleum-based tar or coal-based tar; pitch such as petroleum-based pitch or coal-based pitch; a thermoplastic resin such as polyvinyl chloride, polyvinyl acetate, polyvinyl butyral, polyvinyl alcohol, polyvinylidene chloride, or polyacrylonitrile; a thermosetting resin such as a phenol resin or a furfuryl alcohol resin; a natural resin such as cellulose; and aromatic hydrocarbon such as naphthalene, alkyl naphthalene, or anthracene.

In the present embodiment, these organic compounds may be used alone or in combination of two or more kinds thereof. These organic compounds may be used by being dissolved or dispersed in a solvent as necessary.

Among these organic compounds, from the viewpoint of the cost, tar and pitch are preferable.

The specific surface area of the surface-coated graphite material according to the present embodiment using a nitrogen adsorption BET method is preferably greater than or equal to 1.0 m²/g and less than or equal to 6.0 m²/g and more preferably greater than or equal to 2.0 m²/g and less than or equal to 5.0 m²/g.

In a case where the specific surface area thereof is set to be less than or equal to the above-described upper limit, degradation of the initial charge and discharge efficiency due to an increase in irreversible capacity can be suppressed. Further, in a case where the specific surface area thereof is set to be less than or equal to the above-described upper limit, the stability of the negative electrode slurry described below can be improved.

In a case where the specific surface area thereof is set to be greater than or equal to the above-described lower limit, the area where lithium ions are stored or released is increased and the rate characteristics can be improved.

Further, in a case where the specific surface area is set to be in the above-described range, the binding property of the binder resin can be improved.

From the viewpoint of further improving the battery characteristics of the lithium ion battery to be obtained, the true specific gravity of the surface-coated graphite material according to the present embodiment is preferably greater than or equal to 2.00 g/cm³ and less than or equal to 2.50 g/cm³ and more preferably greater than or equal to 2.10 g/cm³ and less than or equal to 2.30 g/cm³.

From the viewpoint of further improving the battery characteristics of the lithium ion battery to be obtained, the amount of carbonic acid gas to be adsorbed to the surface-coated graphite material according to the present embodiment is preferably greater than or equal to 0.05 ml/g and less than or equal to 1.0 ml/g and more preferably greater than or equal to 0.1 ml/g and less than or equal to 0.5 ml/g.

The coating amount of the amorphous carbon to be calculated by thermogravimetric analysis in the surface-coated graphite material according to the present embodiment is preferably greater than or equal to 0.5% by mass and less than or equal to 10.0% by mass, more preferably greater than or equal to 0.7% by mass and less than or equal to 8.0% by mass, still more preferably greater than or equal to 0.7% by mass and less than or equal to 7.0% by mass, and particularly preferably greater than or equal to 0.8% by mass and less than or equal to 6.5% by mass in a case where the amount of the surface-coated graphite material is set to 100% by mass.

In a case where the coated amount of the amorphous carbon is set to be less than or equal to the above-described upper limit, the area where lithium ions are stored or released is increased and the rate characteristics can be improved.

Further, in a case where the coated amount of the amorphous carbon is set to be greater than or equal to the above-described lower limit, degradation of the initial charge and discharge efficiency due to an increase in irreversible capacity can be suppressed. Further, in a case where the coated amount of the amorphous carbon is set to be greater than or equal to the above-described lower limit, the stability of the negative electrode slurry described below can be improved.

Here, the coating amount of the amorphous carbon can be calculated by thermogravimetric analysis. More specifically, in a case where the surface-coated graphite material is heated to 900° C. at a temperature rising rate of 5° C./min in an oxygen atmosphere using a thermogravimetric analyzer (for example, TGA7 analyzer, manufactured by PerkinElmer Japan Co., Ltd.), the mass decreased during which the temperature at which mass decrease is started is changed to the temperature at which a rate of mass decrease becomes moderate and then the mass decrease is accelerated can be set as the coating amount.

In the surface-coated graphite material according to the present embodiment, the average thickness of the coated layer formed of the amorphous carbon is preferably greater than or equal to 0.5 nm and less than or equal to 100 nm, more preferably greater than or equal to 1 nm and less than or equal to 80 nm, and still more preferably greater than or equal to 2 nm and less than or equal to 50 nm.

Here, the average thickness of the coated layer formed of the amorphous carbon can be obtained by capturing an image of a transmission electron microscope (TEM) and performing measurement using a vernier caliper.

The surface-coated graphite material according to the present embodiment can be produced by performing the following steps (1) to (4).

(1) The graphite material and the organic compound are mixed using a mixer or the like together with a solvent as necessary. In this manner, an organic compound is attached to at least a part of the surface of the graphite material.

(2) In a case of using a solvent, the obtained mixture is heated while being stirred as necessary so that the solvent is removed.

(3) The mixture is heated in a non-oxidizing atmosphere or an inert gas atmosphere such as nitrogen gas, carbonic acid gas, or argon gas, and the attached organic compound is carbonized. In this manner, a surface-coated graphite material formed by coating at least a part of the surface of the graphite material with amorphous carbon having a crystallinity lower than that of the graphite powder is obtained.

The lower limit of the temperature of the heat treatment in this step is not particularly limited because the lower limit thereof is appropriately determined depending on the type or the coating amount of the organic compound, the thermal history, and the like. The lower limit thereof is preferably higher than or equal to 930° C., more preferably higher than or equal to 950° C., and still more preferably higher than or equal to 980° C. In a case where the temperature of the heat treatment is higher than or equal to the above-described lower limit, the amount of water vapor to be adsorbed to the negative electrode active material can be suppressed to be low. As the result, the water vapor saturation adsorption amount of the negative electrode active material layer 103 can be decreased.

Further, the upper limit of the temperature of the heat treatment in this step is not particularly limited because the upper limit thereof is appropriately determined depending on the type or the coating amount of the organic compound, the thermal history, and the like. The upper limit thereof is preferably lower than or equal to 1150° C., more preferably lower than or equal to 1100° C., and still more preferably lower than or equal to 1080° C. In a case where the temperature of the heat treatment is lower than or equal to the above-described upper limit, the amount of water vapor to be adsorbed to the negative electrode active material can be improved. As the result, the water vapor saturation adsorption amount of the negative electrode active material layer 103 can be improved.

The temperature rising rate, the cooling rate, the heat treatment time, and the like are also appropriately determined depending on the type of the organic compound or the thermal history.

In the present embodiment, the coated layer may be subjected to an oxidation treatment after the treatment of coating the graphite material with the organic compound is performed and before the coated layer is carbonized. By oxidizing the coated layer, an increase in crystallinity of the coated layer can be suppressed.

(4) The obtained surface-coated graphite material is subjected to a grinding treatment, a crushing treatment, a classification treatment, and the like as necessary to prepare a surface-coated graphite material having desired properties. This step may be performed before the step of (3) described above or before and after the step of (3) described above. Further, the graphite material before being coated with the organic compound may be subjected to a grinding treatment, a crushing treatment, a classification treatment, and the like.

In order to obtain the surface-coated graphite material according to the present embodiment, it is important to appropriately adjust each of the above-described steps. Here, the method of producing the surface-coated graphite material according to the present embodiment is not limited to the above-described method, and the surface-coated graphite material according to the present embodiment can be obtained by appropriately adjusting various conditions.

From the viewpoint of suppressing side reactions at the time of discharge and charge to suppress a decrease in charge and discharge efficiency, the average particle diameter d₅₀ of the surface-coated graphite material in the volume-based particle size distribution according to a laser diffraction scattering type particle size distribution measuring method is preferably greater than or equal to 1 μm, more preferably greater than or equal to 5 μm, still more preferably greater than or equal to 10 μm, and particularly preferably greater than or equal to 15 μm. Further, from the viewpoints of input and output characteristics and preparation of the electrode (the smoothness and the like of the surface of the electrode), the average particle diameter d₅₀ thereof is preferably less than or equal to 40 μm, more preferably less than or equal to 30 μm, and particularly preferably less than or equal to 25 μm.

The content of the negative electrode active material is preferably greater than or equal to 85 parts by mass and less than or equal to 99 parts by mass, more preferably greater than or equal to 90 parts by mass and less than or equal to 98 parts by mass, and still more preferably greater than or equal to 93 parts by mass and less than or equal to 97.5 parts by mass in a case where the total content of the negative electrode active material layer 103 is set to 100 parts by mass.

(Binder Resin)

The binder resin used for the negative electrode active material layer 103 according to the present embodiment plays a role of binding negative electrode active materials and the negative electrode active material layer 103 and the collector layer 101.

The binder resin according to the present embodiment is not particularly limited as long as the binder resin is capable of forming an electrode and sufficiently has electrochemical stability. For example, from the viewpoint of environmental friendliness, a so-called aqueous binder resin which is used by dispersing a binder resin in an aqueous solvent is preferable.

As the aqueous binder resin contained in the negative electrode active material layer 103 according to the present embodiment, for example, a rubber-based binder resin or an acrylic binder resin can be used. Further, in the present embodiment, the aqueous binder resin indicates a resin which is capable of forming an emulsion aqueous solution by being dispersed in water.

It is preferable that the aqueous binder resin according to the present embodiment is formed of latex particles and used as an emulsion aqueous solution by being dispersed in water. In other words, it is preferable that the aqueous binder resin contained in the negative electrode active material layer 103 according to the present embodiment is formed of latex particles of the aqueous binder resin. In this manner, the aqueous binder resin can be contained in the negative electrode active material layer 103 without inhibiting the contact between the negative electrode active materials, the contact between the conductive assistants and the contact between the negative electrode active material and the conductive assistant.

Further, a highly hydrophilic solvent such as alcohol may be mixed into water that disperses the aqueous binder resin.

Examples of the rubber-based binder resin include styrene-butadiene copolymer rubber.

Examples of the acrylic binder resin include a polymer (a homopolymer or a copolymer) having a unit (hereinafter, referred to as an “acrylic unit”) of acrylic acid, methacrylic acid, acrylic acid ester, methacrylic acid ester, an acrylic acid salt, or a methacrylic acid salt. As this copolymer, a copolymer having an acrylic unit and a styrene unit or a copolymer having an acrylic unit and a silicon unit may be exemplified.

These aqueous binder resins may be used alone or in combination of two or more kinds thereof. Among these, from the viewpoint that the binding property, the affinity for an electrolytic solution, the cost, the electrochemical stability, and the like are excellent, styrene-butadiene copolymer rubber is particularly preferable.

The styrene-butadiene copolymer rubber is a copolymer containing styrene and 1,3-butadiene as main components. Here, the main components indicate that the total content of the constitutional units derived from styrene and the constitutional units derived from 1,3-butadiene in the styrene-butadiene copolymer rubber is greater than or equal to 50% by mass in the content of all polymerization units in the styrene-butadiene copolymer rubber.

The mass ratio (St/BD) of the constitutional units derived from styrene (hereinafter, also referred to as St) to the constitutional units derived from 1,3-butadiene (hereinafter, also referred to as BD) is in a range of, for example, 10/90 to 90/10.

The styrene-butadiene copolymer rubber may be obtained by copolymerizing monomer components other than styrene and 1,3-butadiene. Examples thereof include a conjugated diene monomer, an unsaturated carboxylic acid monomer, and other copolymerizable known monomers.

Examples of the conjugated diene monomer include isoprene, 2,3-dimethyl-1,3-butadiene, 1,3-pentadiene, and piperylene.

Examples of the unsaturated carboxylic acid monomer include acrylic acid, methacrylic acid, maleic acid, fumaric acid, and itaconic acid.

A method of producing the styrene-butadiene copolymer rubber is not particularly limited, and it is preferable that the styrene-butadiene copolymer rubber is produced according to an emulsion polymerization method. In a case where an emulsion polymerization method is used, the styrene-butadiene copolymer rubber can be obtained using latex particles containing the styrene-butadiene copolymer rubber.

A known method of the related art is used as the emulsion polymerization method. For example, the styrene-butadiene copolymer rubber can be produced by adding a polymerization initiator to styrene, 1,3-butadiene, and various copolymerizable monomer components described above preferably in the presence of an emulsifier and performing emulsion polymerization in water.

The average particle diameter of the latex particles containing the styrene-butadiene copolymer rubber to be obtained is not particularly limited, but is preferably greater than or equal to 50 nm and less than or equal to 500 nm, more preferably greater than or equal to 70 nm and less than or equal to 250 nm, still more preferably greater than or equal to 80 nm and less than or equal to 200 nm, and particularly preferably greater than or equal to 90 nm and less than or equal to 150 nm. In a case where the average particle diameter thereof is in the above-described range, the balance between swelling, elution, and the binding property of the aqueous binder resin with respect to the electrolytic solution, and the dispersibility of particles becomes excellent.

Further, the average particle diameter of the latex particles in the present embodiment indicates the volume average particle diameter and can be measured according to a dynamic light scattering method.

The average particle diameter of the latex particles according to a dynamic light scattering method can be measured in the following manner. A dispersion liquid of the latex particles is diluted 200 to 1000 times with water according to the solid content. 5 ml of this diluent is poured into a cell of a measuring device (for example, Microtrac particle size analyzer, manufactured by Nikkiso Co., Ltd.), the conditions for the refractive indices of the solvent (water in the present embodiment) and the polymer according to the sample are input, and then the measurement is performed. At this time, the peak of the obtained volume particle diameter distribution data is set as the average particle diameter of the present embodiment.

The content of the binder resin is preferably greater than or equal to 0.1 parts by mass and less than or equal to 10.0 parts by mass, more preferably greater than or equal to 0.5 parts by mass and less than or equal to 5.0 parts by mass, still more preferably greater than or equal to 0.8 parts by mass and less than or equal to 4.0 parts by mass, and particularly preferably greater than or equal to 1.0 parts by mass and less than or equal to 3.0 parts by mass in a case where the total content of the negative electrode active material layer 103 is set to 100% by mass. In a case where the content of the binder resin is in the above-described range, the balance between the coatability of the negative electrode slurry, the binding property of the binder resin, and the battery characteristics becomes further excellent.

Further, it is preferable that the content of the binder resin is less than or equal to the above-described upper limit from the viewpoint that the proportion of the negative electrode active material is increased and the capacity per electrode mass is increased. It is preferable that the content of the binder resin is greater than or equal to the above-described lower limit from the viewpoint that the peeling of the electrode is suppressed.

(Thickener)

In a case where an aqueous binder resin is used as the binder resin, it is preferable to use a thickener in combination from the viewpoint of ensuring the fluidity suitable for coating. Accordingly, the negative electrode active material layer 103 may further contain a thickener.

The thickener is not particularly limited as long as the thickener is capable of improving the coatability of the electrode slurry used for forming the negative electrode active material layer 103, and examples thereof include water-soluble polymers, for example, cellulose-based polymers such as carboxymethyl cellulose, carboxyethyl cellulose, methyl cellulose, ethyl cellulose, hydroxymethyl cellulose, hydroxypropyl cellulose, and carboxyethyl methyl cellulose, ammonium salts of these, and alkali metal salts of these; polycarboxylic acid; polyethylene oxide; polyvinylpyrrolidone; polyacrylate such as sodium polyacrylate; and polyvinyl alcohol.

Among these, at least one selected from the group consisting of a cellulose-based polymer, an ammonium salt of a cellulose-based polymer, and an alkali metal salt of a cellulose-based polymer is preferable, and carboxymethyl cellulose, an ammonium salt of carboxymethyl cellulose, or an alkali metal salt of carboxymethyl cellulose is more preferable.

These thickeners may be used alone or in combination of two or more kinds thereof.

The content of the thickener is preferably greater than or equal to 0.1 parts by mass and less than or equal to 5.0 parts by mass, more preferably greater than or equal to 0.3 parts by mass and less than or equal to 3.0 parts by mass, and still more preferably greater than or equal to 0.5 parts by mass and less than or equal to 2.0 parts by mass in a case where the total content of the negative electrode active material layer 103 is set to 100% by mass. In a case where the amount of the thickener to be used is in the above-described range, the balance between the coatability of the negative electrode slurry and the binding property of the binder resin becomes further excellent.

(Conductive Assistant)

The conductive assistant contained in the negative electrode active material layer 103 according to the present embodiment is not particularly limited as long as the conductivity of the electrode is improved, and examples thereof include carbon black, Ketjen black, acetylene black, natural graphite, artificial graphite, and carbon fibers. These conductive assistants may be used alone or in combination of two or more kinds thereof.

The content of the conductive assistant is preferably greater than or equal to 0.05 parts by mass and less than or equal to 5.0 parts by mass, more preferably greater than or equal to 0.08 parts by mass and less than or equal to 3.0 parts by mass, still more preferably greater than or equal to 0.1 parts by mass and less than or equal to 2.0 parts by mass, and particularly preferably greater than or equal to 0.2 parts by mass and less than or equal to 1.0 parts by mass in a case where the total content of the negative electrode active material layer 103 is set to 100% by mass. In a case where the content of the conductive assistant is in the above-described range, the balance between the coatability of the negative electrode slurry, the binding property of the binder resin, and the battery characteristics becomes further excellent.

Further, it is preferable that the content of the conductive assistant is less than or equal to the above-described upper limit from the viewpoint that the proportion of the negative electrode active material is increased and the capacity per electrode mass is increased. It is preferable that the content of the conductive assistant is greater than or equal to the above-described lower limit from the viewpoint that the conductivity of the negative electrode is further improved.

The content of the negative electrode active material in the negative electrode active material layer 103 according to the present embodiment is preferably greater than or equal to 85 parts by mass and less than or equal to 99 parts by mass, more preferably greater than or equal to 90 parts by mass and less than or equal to 98 parts by mass, and still more preferably greater than or equal to 93 parts by mass and less than or equal to 97.5 parts by mass in a case where the total content of the negative electrode active material layer 103 is set to 100% by mass. Further, the content of the binder resin is preferably greater than or equal to 0.1 parts by mass and less than or equal to 10.0 parts by mass, more preferably greater than or equal to 0.5 parts by mass and less than or equal to 5.0 parts by mass, and still more preferably greater than or equal to 0.8 parts by mass and less than or equal to 4.0 parts by mass, and particularly preferably greater than or equal to 1.0 parts by mass and less than or equal to 3.0 parts by mass. Further, the content of the thickener is preferably greater than or equal to 0.1 parts by mass and less than or equal to 5.0 parts by mass, more preferably greater than or equal to 0.3 parts by mass and less than or equal to 3.0 parts by mass, and still more preferably greater than or equal to 0.5 parts by mass and less than or equal to 2.0 parts by mass. Further, the content of the conductive assistant is preferably greater than or equal to 0.05 parts by mass and less than or equal to 5.0 parts by mass, more preferably greater than or equal to 0.08 parts by mass and less than or equal to 3.0 parts by mass, still more preferably greater than or equal to 0.1 parts by mass and less than or equal to 2.0 parts by mass, and particularly preferably greater than or equal to 0.2 parts by mass and less than or equal to 1.0 parts by mass.

In a case where the content of each component constituting the negative electrode active material layer 103 is in the above-described range, the balance between the handleability of the negative electrode 100 for a lithium ion battery and the battery characteristics of the obtained lithium ion battery becomes particularly excellent.

From the viewpoint of further improving the energy density of the lithium ion battery to be obtained, the density of the negative electrode active material layer 103 is preferably greater than or equal to 1.30 g/cm³ and more preferably greater than or equal to 1.40 g/cm³.

The upper limit of the density of the negative electrode active material layer 103 is not particularly limited, but is preferably less than or equal to 1.90 g/cm³ from the viewpoints of further improving the permeability of the electrolytic solution into the electrode and further suppressing deposition of lithium on the electrode.

The density of the negative electrode active material layer 103 can be obtained by measuring the mass and the thickness of the negative electrode active material layer 103 having a predetermined size (for example, 5 cm×5 cm), calculating the mass per unit area, and setting the calculated value as the density thereof.

The thickness of the negative electrode active material layer 103 is not particularly limited and can be appropriately set depending on the desired characteristics. For example, the thickness thereof can be set to be large from the viewpoint of the energy density and can be set to be small from the viewpoint of the output characteristics. The thickness of the negative electrode active material layer 103 can be appropriately set within a range of 50 to 1000 μm and preferably in a range of 100 to 800 μm, more preferably in a range of 120 to 500 μm.

(Collector Layer)

The collector layer 101 according to the present embodiment is not particularly limited, and examples thereof include copper, stainless steel, nickel, titanium, or an alloy of these. Among these, from the viewpoints of the cost, the availability, and the electrochemical stability, copper is particularly preferable. Further, the shape of the collector layer 101 is not particularly limited, and the collector layer having a foil shape, a tabular shape, or a mesh shape is preferably used within a range where the thickness of the collector layer is in a range of 0.001 mm to 0.5 mm.

<Method of Producing Negative Electrode for Lithium Ion Battery>

Next, a method of producing the negative electrode 100 for a lithium ion battery according to the present embodiment will be described.

The method of producing the negative electrode 100 for a lithium ion battery according to the present embodiment is different from methods of producing electrodes of the related art. In order to obtain the negative electrode 100 for a lithium ion battery according to the present embodiment in which the water vapor saturation adsorption amount of the negative electrode active material layer 103 is in the above-described range, it is important to highly control the production conditions such as the compounding ratio of the negative electrode active material layer 103, the type of each component constituting the negative electrode active material layer 103, a method of preparing a negative electrode slurry used for forming the negative electrode active material layer 103, a method of drying the negative electrode slurry, a method of pressing the negative electrode, and the like. In other words, the negative electrode 100 for a lithium ion battery according to the present embodiment can be obtained for the first time by employing a production method of highly controlling various factors related to the following five conditions of (A) to (E).

(A) The compounding ratio of the negative electrode active material layer 103

(B) The type of the surface-coated graphite material, the binder resin, the thickener, or the conductive assistant constituting the negative electrode active material layer 103

(C) The method of preparing a negative electrode slurry used for the negative electrode active material layer 103

(D) The method of drying the negative electrode slurry

(E) The method of pressing the negative electrode

Here, for example, as the specific production conditions such as the kneading time, the kneading temperature, and the like of the negative electrode slurry, various conditions can be employed on the premise that the negative electrode 100 for a lithium ion battery according to the present embodiment highly controls various factors related to the above-described five conditions. In other words, in regard to the points other than the point of highly controlling various factors related to the above-described five conditions, the negative electrode 100 for a lithium ion battery according to the present embodiment can be prepared by employing a known method.

Hereinafter, an example of the method of producing the negative electrode 100 for a lithium ion battery according to the present embodiment will be described on the premise that various factors related to the above-described five conditions are highly controlled.

It is preferable that the method of producing the negative electrode 100 for a lithium ion battery according to the present embodiment includes the following three steps (1) to (3).

(1) Step of mixing the surface-coated graphite material, the binder resin, the thickener, and the conductive assistant to prepare a negative electrode slurry

(2) Step of coating the collector layer 101 with the obtained negative electrode slurry and drying the layer to form the negative electrode active material layer 103

(3) Step of pressing the negative electrode active material layer 103 formed on the collector layer 101 together with the collector layer 101

Hereinafter, each step will be described.

First, (1) the surface-coated graphite material, the binder resin, the thickener, and the conductive assistant are mixed to prepare a negative electrode slurry. Since the types and the compounding ratio of the negative electrode active material, the binder resin, the thickener, and the conductive assistant have been described above, the description thereof will not be repeated here.

The negative electrode slurry is obtained by dispersing or dissolving the surface-coated graphite material, the aqueous binder resin, the thickener, and the conductive assistant in a solvent such as water.

As the procedures of mixing respective components, it is preferable that the negative electrode slurry is prepared by dry-mixing the surface-coated graphite material and the conductive assistant, adding an emulsion aqueous solution of an aqueous binder resin and a thickener solution, and a solvent such as water thereto as necessary, and wet-mixing the components.

In this manner, the dispersibility of the conductive assistant and the aqueous binder resin in the negative electrode active material layer 103 is improved, uneven distribution of the aqueous binder resin, the thickener, and the conductive assistant on the surface of the negative electrode active material layer 103 can be suppressed, and the permeability of water vapor into the negative electrode active material layer 103 can be improved. As the result, the water vapor saturation adsorption amount of the negative electrode active material layer 103 can be further improved.

At this time, the mixer to be used is not particularly limited and a known mixer such as a ball mill or a planetary mixer can be used.

Next, (2) the collector layer 101 is coated with the obtained negative electrode slurry and dried to form the negative electrode active material layer 103. In this step, for example, the collector layer 101 is coated with the negative electrode slurry obtained by performing the step (1), the slurry is dried, and the solvent is removed therefrom so that the negative electrode active material layer 103 is formed on the collector layer 101.

A known method can be typically used as a method of coating the collector layer 101 with the negative electrode slurry. Examples of the method include a reverse roll method, a direct roll method, a doctor blade method, a knife method, an extrusion method, a curtain method, a gravure method, a bar method, a dip method, and a squeeze method. Among these, from the viewpoint that an excellent surface state of a coated layer can be obtained along with the drying property and the physical property such as the viscosity of the negative electrode slurry, a doctor blade method, a knife method, or an extrusion method is preferable.

Only one or both surfaces of the collector layer 101 may be coated with the negative electrode slurry. At the time of coating both surfaces of the collector layer 101, the surfaces may be coated sequentially or simultaneously. Further, the surfaces of the collector layer 101 may be coated continuously or intermittently. The thickness, the length, and the width of the coated layer can be appropriately determined depending on the size of the battery.

As the method of drying the negative electrode slurry applied to the collector layer 101, it is preferable that the slurry is carefully dried at a low temperature of 40° C. to 80° C. for a long period of time.

In this manner, uneven distribution of the aqueous binder resin, the thickener, and the conductive assistant on the surface of the negative electrode active material layer 103 can be suppressed, and the permeability of water vapor into the negative electrode active material layer 103 can be improved. As the result, the water vapor saturation adsorption amount of the negative electrode active material layer 103 can be further improved.

Further, after the negative electrode active material layer 103 is formed, it is preferable that the negative electrode active material layer 103 is dried at a high temperature of 100° C. to 150° C. so that the moisture in the negative electrode active material layer 103 is removed.

Next, (3) the negative electrode active material layer 103 formed on the collector layer 101 and the collector layer 101 are pressed together. As the method of pressing the layers, roll press that enables a linear pressure to be increased and a uniform pressure to be applied to the negative electrode active material layer 103 in the film thickness direction is preferable. In this manner, it is possible to prevent the density of the surface of the negative electrode active material layer 103 from being extremely increased than the density of the collector layer 101 side of the negative electrode active material layer 103, and the permeability of water vapor into the negative electrode active material layer 103 can be improved. As the result, the water vapor saturation adsorption amount of the negative electrode active material layer 103 can be improved.

<Lithium Ion Battery>

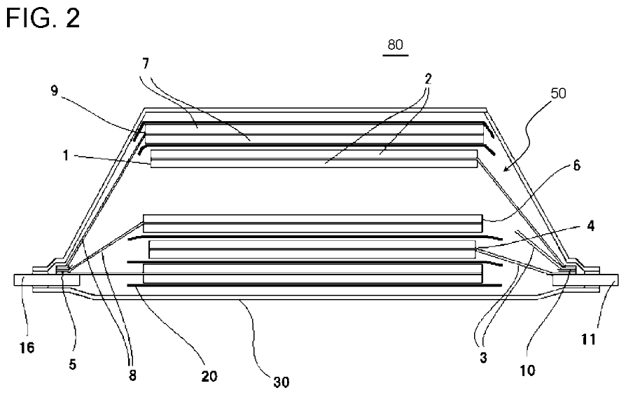

FIG. 2 is a cross-sectional view illustrating an example of the structure of a lithium ion battery 80 according to an embodiment of the present invention. The lithium ion battery 80 according to the present embodiment is a lithium ion secondary battery.

The lithium ion battery 80 according to the present embodiment includes the negative electrode 100 for a lithium ion battery.

For example, as illustrated in FIG. 2, the lithium ion battery 80 according to the present embodiment includes a battery main body 50 which includes one or more power generation elements formed by laminating a positive electrode 1 having a positive electrode active material layer 2 and a positive electrode collector 3, an electrolyte layer having a separator 20 and an electrolytic solution, and a negative electrode 6 having a negative electrode active material layer 7 and a negative electrode collector 8 in this order; an exterior body 30 which encloses the battery main body 50 therein; a positive electrode terminal 11 which is electrically connected to the positive electrode collector 3 and at least partially exposed to the outside of the exterior body 30; and a negative electrode terminal 16 which is electrically connected to the negative electrode collector 8 and at least partially exposed to the outside of the exterior body 30. Further, the negative electrode 6 includes the negative electrode 100 for a lithium ion battery according to the present embodiment.

The lithium ion battery 80 according to the present embodiment can be prepared according to a known method.

The form or the type of the lithium ion battery 80 according to the present embodiment is not particularly limited, but can be configured as follows.

FIG. 2 schematically illustrates an example of the configuration in which the lithium ion battery 80 according to the present embodiment is a lamination type lithium ion battery. The lamination type lithium ion battery includes the battery main body 50 including one or more power generation elements formed by alternately laminating the positive electrodes 1 and the negative electrodes 6 through the separator 20. These power generation elements and an electrolytic solution (not illustrated) are stored in a container formed of the exterior body 30. The power generation element is configured such that the positive electrode terminal 11 and the negative electrode terminal 16 are electrically connected thereto and the positive electrode terminal 11 and the negative electrode terminal 16 are partially or entirely drawn out to the outside of the exterior body 30.

In the positive electrode 1, a coated portion (positive electrode active material layer 2) and an uncoated portion of the positive electrode active material are respectively provided on the front and rear side of the positive electrode collector 3. Further, in the negative electrode 6, a coated portion (negative electrode active material layer 7) and an uncoated portion of the negative electrode active material are respectively provided on the front and rear side of the negative electrode collector 8.

Positive electrode tabs 10 for connecting the uncoated portion of the positive electrode active material in the positive electrode collector 3 to the positive electrode terminal 11, and negative electrode tabs 5 for connecting the uncoated portion of the negative electrode active material in the negative electrode collector 8 to the negative electrode terminal 16 are provided.

The positive electrode tabs 10 are collectively provided on the positive electrode terminal 11, and the positive electrode tabs 10 and the positive electrode terminal 11 are connected with each other through ultrasonic welding or the like. Further, the negative electrode tabs 5 are collectively provided on the negative electrode terminal 16, and the negative electrode tabs 5 and the negative electrode terminal 16 are connected with each other through ultrasonic welding or the like. Further, one end of the positive electrode terminal 11 is drawn out to the outside of the exterior body 30, and one end of the negative electrode terminal 16 is also drawn out to the outside of the exterior body 30.

An insulation member can be formed at a boundary portion 4 between the coated portion and the uncoated portion of the positive electrode active material as necessary, and the insulation member can be formed not only at the boundary portion 4 but also in the vicinity of both boundary portions of the positive electrode tabs and the positive electrode active materials.

Similarly, an insulation member can be formed at a boundary portion 9 between the coated portion and the uncoated portion of the negative electrode active material as necessary, and the insulation member can be formed in the vicinity of both boundary portions of the negative electrode tabs and the negative electrode active materials.

Typically, the external dimension of the negative electrode active material layer 7 is larger than the external dimension of the positive electrode active material layer 2 and smaller than the external dimension of the separator 20.

Next, examples of each constitutional unit of the lithium ion battery 80 according to the present embodiment will be described.

(Positive Electrode)

The positive electrode 1 is not particularly limited and can be appropriately selected from positive electrodes which can be used for known lithium ion batteries depending on the applications thereof. The positive electrode 1 includes the positive electrode active material layer 2 and the positive electrode collector 3.

As the positive electrode material used for the positive electrode 1, a material which is capable of reversibly releasing and storing lithium ions and has a high electronic conductivity so that electron transport is easily carried out is preferable.

Examples of the positive electrode active material used for the positive electrode 1 include a composite oxide of lithium and a transition metal such as a lithium nickel composite oxide, a lithium cobalt composite oxide, a lithium manganese composite oxide, or a lithium-manganese-nickel composite oxide; a transition metal sulfide such as TiS₂, FeS, or MoS₂; a transition metal oxide such as MnO, V₂O₅, V₆O₁₃, or TiO₂; and an olivine type lithium phosphorus oxide.

The olivine type lithium phosphorus oxide contains, for example, at least one element selected from the group consisting of Mn, Cr, Co, Cu, Ni, V, Mo, Ti, Zn, Al, Ga, Mg, B, Nb, and Fe, lithium, phosphorus, and oxygen. In order to improve the characteristics of these compounds, some elements may be substituted with other elements.

Among these, an olivine type lithium iron phosphorus oxide, a lithium cobalt composite oxide, a lithium nickel composite oxide, a lithium manganese composite oxide, or a lithium-manganese-nickel composite oxide is preferable. These positive electrode active materials have a high action potential, a high capacity, and a large energy density.

The positive electrode active materials may be used alone or in combination of two or more kinds thereof.

A binder resin, a conductive assistant, and the like can be appropriately added to the positive electrode active material. As the conductive assistant, carbon black, carbon fibers, graphite, or the like can be used. Further, as the binder resin, polyvinylidene fluoride (PVdF), polytetrafluoroethylene (PTFE), carboxymethyl cellulose, modified acrylonitrile rubber particles, or the like can be used.

The positive electrode 1 is not particularly limited and can be produced according to a known method. For example, a method of dispersing the positive electrode active material, the conductive assistant, and the binder resin in an organic solvent to obtain a slurry, coating the positive electrode collector 3 with the slurry, and drying the slurry can be employed.

Since the thickness or the density of the positive electrode 1 is appropriately determined depending on the applications of the battery or the like, the thickness or the density thereof is not particularly limited and can be typically set based on known information.

The positive electrode collector 3 is not particularly limited, and those which have been typically used for lithium ion batteries. Examples thereof include aluminum, stainless steel, nickel, titanium, or an alloy of these. Among these, from the viewpoints of the cost, the availability, and the electrochemical stability, aluminum is preferable as the positive electrode collector 3.

(Negative Electrode)

The negative electrode 6 includes the negative electrode 100 for a lithium ion battery according to the present embodiment. Further, the negative electrode 6 may further include a negative electrode which can be used for a known lithium ion battery depending on the applications thereof and the like. Hereinafter, the negative electrode 6 other than the negative electrode 100 for a lithium ion battery according to the present embodiment will be described.

The negative electrode 6 includes the negative electrode active material layer 7 and the negative electrode collector 8.

The negative electrode active material used for the negative electrode 6 other than the negative electrode 100 for a lithium ion battery according to the present embodiment can be appropriately set depending on the applications thereof as long as the material can be used for a negative electrode.

Specific examples of the material which can be used as the negative electrode active material include carbon materials such as artificial graphite, natural graphite, amorphous carbon, diamond-like carbon, fullerene, carbon nanotubes, and carbon nanohorn; lithium metal materials; alloy-based materials such as silicon and tin; oxide-based materials such as Nb₂O₅ and TiO₂; and composites of these.

The negative electrode active material may be used alone or in combination of two or more kinds thereof.

Further, similar to the positive electrode active material, a binder resin, a conductive assistant, and the like can be appropriately added to the negative electrode active material. As these binders or conductive agents, those which can be added to the positive electrode active material can be used.

As the negative electrode collector 8, copper, stainless steel, nickel, titanium, or an alloy of these can be used. Among these, copper is particularly preferable.

Further, the negative electrode 6 according to the present embodiment can be produced according to a known method. For example, a method of dispersing the negative electrode active material and the binder resin in an organic solvent to obtain a slurry, coating the negative electrode collector 8 with the slurry, and drying the slurry can be employed.

(Electrolyte Layer)

An electrolyte layer is a layer disposed so as to be interposed between the positive electrode 1 and the negative electrode 6. The electrolyte layer includes the separator 20 and an electrolytic solution, and examples thereof include those obtained by allowing a porous separator to be impregnated with a nonaqueous electrolytic solution.

The separator 20 is not particularly limited as long as the separator electrically insulating the positive electrode 1 and the negative electrode 6 and has a function of transmitting lithium ions. For example, a porous separator can be used.

As the porous separator, a porous resin film is exemplified. Examples of the resin constituting the porous resin film include polyolefin, polyimide, polyvinylidene fluoride, and polyester. As the separator 20, a porous polyolefin film is preferable, and a porous polyethylene film or a porous polypropylene film is more preferable.

The polypropylene-based resin constituting the porous polypropylene film is not particularly limited, and examples thereof include propylene homopolymers and copolymers of propylene and other olefins. Among these, propylene homopolymers (homopolypropylene) are preferable. The polypropylene-based resin may be used alone or in combination of two or more kinds thereof.

Further, examples of olefins to be copolymerized with propylene include α-olefins such as ethylene, 1-butene, 1-pentene, 4-methyl-1-pentene, 1-hexene, 1-octene, 1-nonene, and 1-decene.

The polyethylene-based resin constituting the porous polyethylene film is not particularly limited, and examples thereof include ethylene homopolymers and copolymers of ethylene and other olefins. Among these, ethylene homopolymers (homopolypropylene) are preferable. The polyethylene-based resin may be used alone or in combination of two or more kinds thereof.

Further, examples of olefins to be copolymerized with ethylene include α-olefins such as 1-butene, 1-pentene, 4-methyl-1-pentene, 1-hexene, 1-octene, 1-nonene, and 1-decene.

From the viewpoint of the balance between the mechanical strength and the lithium ion conductivity, the thickness of the separator 20 is preferably greater than or equal to 5 μm and less than or equal to 50 μm and more preferably greater than or equal to 10 μm and less than or equal to 40 μm.

From the viewpoint of further improving the heat resistance, it is preferable that the separator 20 further includes a ceramic layer on at least one surface of the porous resin film.

In a case where the separator 20 further includes the ceramic layer, thermal contraction can be further reduced and short circuit between electrodes can be prevented.

The ceramic layer can be formed by, for example, coating the porous resin layer with a ceramic layer-forming material and drying the material. As the ceramic layer-forming material, a material obtained by dissolving or dispersing an inorganic filler and a binder resin in an appropriate solvent can be used.

The inorganic filler used for this ceramic layer can be appropriately selected from known materials which have been used for separators of lithium ion batteries. For example, a highly insulating oxide, a nitride, a sulfide, a carbide, or the like is preferable, and one or two or more inorganic compounds prepared in a particle shape, which are selected from oxide-based ceramics such as titanium oxide, alumina, silica, magnesia, zirconia, zinc oxide, iron oxide, ceria, and yttria are more preferable. Among these, titanium oxide or alumina is preferable.

The binder resin is not particularly limited, and examples thereof include a cellulose-based resin such as carboxymethyl cellulose (CMC); an acrylic resin; and a fluorine-based resin such as polyvinylidene fluoride (PVDF). The binder resin may be used alone or in combination of two or more kinds thereof.

The solvent in which these components are dissolved or dispersed is not particularly limited and can be used by being appropriately selected from water, alcohols such as ethanol, N-methylpyrrolidone (NMP), toluene, dimethyl carbonate (DMC), and ethyl methyl carbonate (EMC).

From the viewpoints of the mechanical strength, the handleability, and the lithium ion conductivity, the thickness of the ceramic layer is preferably greater than or equal to 1 μm and less than or equal to 20 μm and more preferably greater than or equal to 1 μm and less than or equal to 12 μm.

The electrolytic solution according to the present embodiment is obtained by dissolving an electrolyte in a solvent.

As the electrolyte, a lithium salt is exemplified, and the electrolyte may be selected depending on the type of the electrode active material. Examples thereof include LiClO₄, LiBF₆, LiPF₆, LiCF₃SO₃, LiCF₃CO₂, LiAsF₆, LiSbF₆, LiB₁₀Cl₁₀, LiAlCl₄, LiCl, LiBr, LiB(C₂H₅)₄, CF₃SO₃Li, CH₃SO₃Li, LiC₄F₉SO₃, Li(CF₃SO₂)₂N, and lower fatty acid lithium carboxylate.

The solvent that dissolves the electrolyte is not particularly limited as long as the solvent has been typically used as a liquid that dissolves an electrolyte. Examples thereof include carbonates such as ethylene carbonate (EC), propylene carbonate (PC), butylene carbonate (BC), dimethyl carbonate (DMC), diethyl carbonate (DEC), methyl ethyl carbonate (MEC), and vinylene carbonate (VC); lactones such as γ-butyrolactone and γ-valerolactone; ethers such as trimethoxymethane, 1,2-dimethoxyethane, diethyl ether, tetrahydrofuran, and 2-methyl tetrahydrofuran; sulfoxides such as dimethyl sulfoxide; oxolanes such as 1,3-dioxolane and 4-methyl-1,3-dioxolane; nitrogen-containing solvents such as acetonitrile, nitromethane, formamide, and dimethylformamide; organic acid esters such as methyl formate, methyl acetate, ethyl acetate, butyl acetate, methyl propionate, and ethyl propionate; phosphoric acid trimester and diglymes; triglymes; sulfolanes such as sulfolane and methyl sulfolane; oxazolidinones such as 3-methyl-2-oxazolidinone; and sultones such as 1,3-propane sultone, 1,4-butane sultone, and naphthasultone. These may be used alone or in combination of two or more kinds thereof.

(Exterior Body)

As the exterior body 30 according to the present embodiment, a known member can be used. From the viewpoint of reducing the weight of the battery, it is preferable to use a laminate film having a metal layer and a thermally fusible resin layer. As the metal layer, a layer having a barrier property for preventing leakage of an electrolytic solution or entrance of moisture from the outside can be selected. For example, stainless steel (SUS), aluminum, copper, or the like can be used.

The resin material constituting the thermally fusible resin layer is not particularly limited, and examples thereof include polyethylene, polypropylene, nylon, and polyethylene terephthalate (PET).

In the present embodiment, the exterior body 30 can be formed by disposing thermally fusible resin layers of the laminate film so as to face each other through the battery main body 50 and thermally fusing the periphery of a portion that stores the battery main body 50. A resin layer such as a nylon film or a polyester film can be provided on a surface of the exterior body opposite to the surface where the thermally fusible resin layers are formed.

(Electrode Terminal)

In the present embodiment, known members can be used as the positive electrode terminal 11 and the negative electrode terminal 16. As the positive electrode terminal 11, for example, a terminal formed of aluminum or an aluminum alloy can be used. Further, as the negative electrode terminal 16, for example, a terminal formed of copper, a copper alloy, or those obtained by plating copper or a copper alloy with nickel can be used. Each terminal is drawn out to the outside of the container, and a thermally fusible resin can be provided in advance on a site positioned in a portion where the periphery of the exterior body 30 in each terminal is thermally welded.

(Insulation Member)

In a case where an insulation member is formed in the boundary portions 4 and 9 between the coated portion and the uncoated portion of the active material, polyimide, glass fibers, polyester, polypropylene, or those containing these in the configuration can be used. The insulation member can be formed by heating these members to be welded to the boundary portions 4 and 9 or coating the boundary portions 4 and 9 with a gel-like resin and drying the resin.

Hereinbefore, the embodiments of the present invention have been described, but these are merely examples of the present invention, and various configurations other than these examples may be employed.

Further, the present invention is not limited to the above-described embodiment, and modifications, improvements, and the like can be made within the range where the purpose of the present invention can be achieved.

### EXAMPLES

Hereinafter, the present invention will be described based on the following examples and comparative examples, but the present invention is not limited thereto.

<Preparation of Surface-Coated Graphite Material>

Surface-coated graphite materials 1 to 6 were prepared in the following manner. Hereinafter, the average particle diameter d₅₀ was measured using a device of MT3000 (manufactured by Microtrac Inc.) and the specific surface area was measured using Quanta Sorb (manufactured by Quantachrome Corporation) according to the nitrogen adsorption BET method.

Further, in a case where the surface-coated graphite material was heated to 900° C. at a temperature rising rate of 5° C./min in an oxygen atmosphere using a thermogravimetric analyzer (TGA7 analyzer, manufactured by PerkinElmer Japan Co., Ltd.), the mass decreased during which the temperature at which mass decrease was started was changed to the temperature at which a rate of mass decrease became moderate and then the mass decrease was accelerated was set as the coating amount of the amorphous carbon.

Further, the adsorption amount of carbonic acid gas was measured by drying 3 g of a surface-coated graphite material at 220° C. for 2 hours in a nitrogen atmosphere to obtain a measurement sample using NOVA2000 (manufactured by Quantachrome Corporation) according to a constant capacity method. The adsorption amount thereof is a value converted to a standard state (STP).

The true specific gravity was measured according to a pycnometer method.

(Preparation of Surface-Coated Graphite Material 1)

A surface-coated graphite material 1 (average particle diameter d₅₀: 17.5 μm, specific surface area according to nitrogen adsorption BET method: 3.2 m2/g) whose surface was at least partially coated with amorphous carbon was prepared in the following manner.

95 parts by mass of natural graphite powder and 5 parts by mass of coal-based pitch powder were simply mixed using a V blender in a solid phase. The obtained mixed powder was put into a graphite crucible and subjected to a heat treatment at 950° C. for 10 hours in a nitrogen stream so that the coal-based pitch powder was baked to form amorphous carbon, thereby obtaining the surface-coated graphite material 1 whose surface was coated with amorphous carbon. The physical properties of the obtained surface-coated graphite material 1 are listed in Table 1.

(Preparation of Surface-Coated Graphite Materials 2 to 6)

Surface-coated graphite materials 2 to 6 were respectively prepared in the same manner as that for the surface-coated graphite material 1 except that the temperatures of baking the coal-based pitch powder were respectively changed to the temperatures listed in Table 1 from 950° C. The physical properties of the obtained surface-coated graphite materials 2 to 6 are listed in Table 1.

TABLE 1

| | | | Average | | Adsorption | True |
|---|---|---|---|---|---|---|
| | Baking | Specific | particle | Coating amount of | amount of | specific |
| | temperature | surface area | diameter d₅₀ | amorphous carbon | carbonic acid | gravity |
| | [° C.] | [m²/g] | [μm] | [% by mass] | gas | [g/cm³] |
| Surface-coated | 950 | 3.20 | 17.5 | 5 | 0.3 | 2.25 |
| graphite material 1 | | | | | | |
| Surface-coated | 1000 | 3.10 | 17.6 | 5 | 0.3 | 2.25 |
| graphite material 2 | | | | | | |
| Surface-coated | 1050 | 3.15 | 17.6 | 5 | 0.3 | 2.25 |
| graphite material 3 | | | | | | |
| Surface-coated | 1100 | 3.10 | 18.0 | 5 | 0.3 | 2.25 |
| graphite material 4 | | | | | | |
| Surface-coated | 900 | 3.25 | 18.0 | 5 | 0.3 | 2.25 |
| graphite material 5 | | | | | | |
| Surface-coated | 1200 | 3.00 | 18.2 | 5 | 0.3 | 2.26 |
| graphite material 6 | | | | | | |

### Example 1

(Preparation of Negative Electrode)

A negative electrode was prepared in the following manner. The surface-coated graphite material 1 was used as the negative electrode active material. Latex particles formed of styrene-butadiene copolymer rubber were used as the aqueous binder resin, carboxymethyl cellulose was used as the thickener, and carbon black (average particle diameter d₅₀: 100 nm) was used as the conductive assistant.

First, the surface-coated graphite material 1 serving as the negative electrode active material and the conductive assistant were dry-mixed. Next, a thickener aqueous solution, an emulsion aqueous solution containing an aqueous binder resin, and water were added to the obtained mixture and wet-mixed to prepare a negative electrode slurry. The negative electrode was prepared by coating both surfaces of copper foil serving as the negative electrode collector with the negative electrode slurry and drying the slurry.

Here, the negative electrode slurry was dried by being heated at 50° C. for 15 minutes. A negative electrode active material layer was formed on the copper foil by drying the negative electrode slurry. Further, after the slurry was dried, a heat treatment was performed thereon at 110° C. for 10 minutes so that the moisture in the negative electrode was completely removed.

Subsequently, the copper foil and the negative electrode active material layer were pressed through roll press to obtain a negative electrode (coating amount of negative electrode active material layer per one surface: 9 mg/cm²) having the negative electrode active material layer with a density of 1.46 g/cm³.

Further, the compounding ratio between the negative electrode active material, the aqueous binder resin, the thickener, and the conductive assistant (negative electrode active material/aqueous binder resin/thickener/conductive assistant) was 96.7/2/1/0.3 (mass ratio).

<Preparation of Positive Electrode>

Mixed oxides (positive electrode active material) obtained by mixing LiMn₂O₄ and LiNi_{0.85}Co_{0.15}O₂ at a mass ratio of 78:22 were used as the positive electrode active material, carbon black was used as the conductive assistant, and polyvinylidene fluoride was used as the binder resin. These were dispersed or dissolved in N-methyl-pyrrolidone (NMP) to prepare a positive electrode slurry. Aluminum foil serving as a positive electrode collector was coated with this positive electrode slurry, and the slurry was dried. Next, the aluminum foil and the positive electrode active material layer were pressed through roll press to obtain a positive electrode having the positive electrode active material layer with a density of 3.0 g/cm³.

<Preparation of Lithium Ion Battery>

The obtained positive electrode and negative electrode were laminated through a separator formed of a porous polyolefin film having a thickness of 20 μm, and a negative electrode terminal and a positive electrode terminal were provided thereon, thereby obtaining a laminate. Next, a lamination type lithium ion battery was obtained by accommodating the obtained laminate and an electrolytic solution obtained by dissolving LiPF₆ as an electrolyte in a mixed solvent containing ethylene carbonate and diethyl carbonate (ethylene carbonate:diethyl carbonate=3:7 (volume ratio)) such that the concentration of LiPF₆ was set to 1.0 mol/L with a laminate film.

<Evaluation>

(1) Measurement of Water Vapor Saturation Adsorption Amount of Negative Electrode Active Material Layer

The water vapor saturation adsorption amount of the negative electrode active material layer was measured by drying 3.0 g of the negative electrode active material layer at 220° C. for 2 hours in a nitrogen atmosphere to obtain a measurement sample using BELSORP (manufactured by Bel Japan Inc.).

The water vapor adsorption amount until the equivalent pressure in the sample tube at 25° C. reached 0.31 kPa (corresponding to relative pressure P/P₀=0.1) was acquired according to a constant capacity method, and the water vapor saturation adsorption amount was acquired using the following equation.

Water vapor saturation adsorption amount [cm³ (STP)/g]=(total water vapor introduction amount−amount of water vapor required to set relative pressure (P/P₀) to 0.1)/mass of negative electrode active material layer.

Here, the water vapor saturation adsorption amount is a value converted to a standard state (STP).

(2) Measurement of Amount of Gas to be Generated

The obtained lithium ion battery was fully charged, and the amount of gas to be generated was acquired based on a change in volume before and after the charge. A case where the amount of gas to be generated was less than or equal to 2.5 cm³, this was evaluated as A. In addition, a case where the amount of gas to be generated was greater than 2.5 cm³, this was evaluated as B.

(3) Measurement of Aging Efficiency

The lithium ion battery in a fully charge state was allowed to stand in an environment of a temperature of 50° C. for 14 days, and the aging efficiency (=100× recovery capacity/charge capacity before standing) was calculated based on the recovery capacity after 14 days. The evaluation was performed based on the following criteria.

A: The aging efficiency was greater than or equal to 83%.

B: The aging efficiency was less than 83%.

The evaluation results are listed in Table 2.

### Examples 2 to 4 and Comparative Examples 1 and 2

Each negative electrode and each lithium ion battery were prepared in the same manner as in Example 1 except that the surface-coated graphite material 1 was changed to the surface-coated graphite materials 2 to 6 listed in Table 1, and each evaluation was performed. The evaluation results are listed in Table 2.

TABLE 2

| | | Water vapor | | |
|---|---|---|---|---|
| | | saturation | Amount of | |
| | Used | adsorption | gas to be | Aging |
| | surface-coated | amount | generated | efficiency |
| | graphite material | [cm³ (STP)/g] | [—] | [—] |
| Example 1 | 1 | 0.12 | A | A |
| Example 2 | 2 | 0.08 | A | A |
| Example 3 | 3 | 0.05 | A | A |
| Example 4 | 4 | 0.04 | A | A |
| Comparative | 5 | 0.28 | A | B |
| Example 1 | | | | |
| Comparative | 6 | 0.02 | B | A |
| Example 2 | | | | |

Based on Table 2, in a case of the lithium ion battery of each example in which the negative electrode having a negative electrode active material layer with a water vapor saturation adsorption amount of greater than or equal to 0.03 cm³ (STP)/g and less than or equal to 0.25 cm³ (STP)/g was used, the aging efficiency was excellent and the amount of gas to be generated was suppressed to be low.

On the contrary, in a case of the lithium ion battery of Comparative Example 1 in which the negative electrode having a negative electrode active material layer with a water vapor saturation adsorption amount of greater than 0.25 cm³ (STP)/g was used, the aging efficiency was poor. Further, in a case of the lithium ion battery of Comparative Example 2 in which the negative electrode having a negative electrode active material layer with a water vapor saturation adsorption amount of less than 0.03 cm³ (STP)/g was used, swelling of the battery was not able to be suppressed.

As described above, it was understood that a lamination type lithium ion battery which has excellent aging efficiency and is unlikely to be swollen can be realized by using a negative electrode having a negative electrode active material layer with a water vapor saturation adsorption amount of greater than or equal to 0.03 cm³ (STP)/g and less than or equal to 0.25 cm³ (STP)/g.

This application claims priority based on Japanese Patent Application No. 2017-069661 filed on Mar. 31, 2017, the entire contents of which are incorporated herein by reference.

1. A negative electrode for a lithium ion battery comprising:
a collector layer; and
a negative electrode active material layer which is provided on at least one surface of the collector layer and contains, as a negative electrode active material, a surface-coated graphite material formed by coating at least a part of a surface with amorphous carbon,
wherein a water vapor saturation adsorption amount of the negative electrode active material layer measured using the following method is greater than or equal to 0.03 cm³ (STP)/g and less than or equal to 0.25 cm³ (STP)/g,
(method)
3.0 g of the negative electrode active material layer is dried at 220° C. for 2 hours in a nitrogen atmosphere, the dried negative electrode active material layer is allowed to adsorb water vapor at 25° C. using a constant capacity method, and the water vapor saturation adsorption amount of the negative electrode active material layer is calculated.

2. The negative electrode for a lithium ion battery according to claim 1,
wherein a specific surface area of the surface-coated graphite material according to a nitrogen adsorption BET method is greater than or equal to 1.0 m²/g and less than or equal to 6.0 m²/g.

3. The negative electrode for a lithium ion battery according to claim 1,
wherein a true specific gravity of the surface-coated graphite material is greater than or equal to 2.00 g/cm³ and less than or equal to 2.50 g/cm³.

4. The negative electrode for a lithium ion battery according to claim 1,
wherein an amount of carbonic acid gas to be adsorbed to the surface-coated graphite material is greater than or equal to 0.05 ml/g and less than or equal to 1.0 ml/g.

5. The negative electrode for a lithium ion battery according to claim 1,
wherein an average particle diameter d₅₀ of the surface-coated graphite material in volume-based particle size distribution according to a laser diffraction scattering type particle size distribution measuring method is greater than or equal to 1 μm and less than or equal to 40 μm.

6. The negative electrode for a lithium ion battery according to claim 1,
wherein a coating amount of the amorphous carbon to be calculated by thermogravimetric analysis is greater than or equal to 0.5% by mass and less than or equal to 10.0% by mass in a case where the amount of the surface-coated graphite material is set to 100% by mass.

7. The negative electrode for a lithium ion battery according to claim 1,
wherein an average thickness of a coated layer formed of the amorphous carbon in the surface-coated graphite material is greater than or equal to 0.5 nm and less than or equal to 100 nm.

8. The negative electrode for a lithium ion battery according to claim 1,
wherein the negative electrode active material layer further contains a binder resin.

9. The negative electrode for a lithium ion battery according to claim 8,
wherein the binder resin contains an aqueous binder resin.

10. The negative electrode for a lithium ion battery according to claim 8,
wherein the content of the binder resin is greater than or equal to 0.1 parts by mass and less than or equal to 10.0 parts by mass in a case where the total content of the negative electrode active material layer is set to 100 parts by mass.

11. The negative electrode for a lithium ion battery according to claim 1,
wherein the negative electrode active material layer further contains a conductive assistant, and
the content of the conductive assistant is greater than or equal to 0.05 parts by mass and less than or equal to 5.0 parts by mass in a case where the total content of the negative electrode active material layer is set to 100 parts by mass.

12. A lithium ion battery comprising:
the negative electrode for a lithium ion battery according to claim 1.

13. A lithium ion battery comprising:
a battery main body which includes one or more power generation elements formed by lamination of the negative electrode for a lithium ion battery according to claim 1, an electrolyte layer, and a positive electrode in this order; and
an exterior body which encloses the battery main body.

14. The lithium ion battery according to claim 13,
wherein the exterior body includes a laminate film.
